(19) United States
(12) Patent Application Publication
(10) Pub. No.: US 2024/0227494 A1
(43) Pub. Date: Jul. 11, 2024

(54) VEHICLE FOR PASSENGER TRANSPORT WITH AN ELECTRIC, COOLED DRIVE DEVICE

(71) Applicant: Siemens Mobility GmbH, München (DE)

(72) Inventors: Irfan Kasap, Herne (DE); Markus Schmitz, Langerwehe (DE)

(21) Appl. No.: 18/559,098

(22) PCT Filed: Apr. 1, 2022
(86) PCT No.: PCT/EP2022/058776

§ 371 Date: Nov. 6, 2023

(30) Foreign Application Priority Data
May 4, 2021 (DE) 10 2021 204 488.3

(51) Int. Cl. B60H 1/00

(52) U.S. Cl. CPC B60H 1/00371; B60H 1/00899; B60H 2001/00961

(57) ABSTRACT

A vehicle for passenger transport has an electric drive device that is continuously cooled by way of a chiller during operation of the vehicle. An air conditioner for air conditioning a passenger interior compartment of the vehicle includes an external heat exchanger for removing heat from a surrounding area of the vehicle in heat pump operation, wherein ambient air is guided past the external heat exchanger by a fan which is assigned to the external heat exchanger. The electric drive device is cooled by way of a cooling circuit which contains coolant that is temperature-controlled by the chiller. A waste-heat heat exchanger which is subjected to cooling medium that flows back from the electric drive device to the chiller is connected upstream of the external heat exchanger of the air conditioner, relative to the ambient air stream generated by the fan.

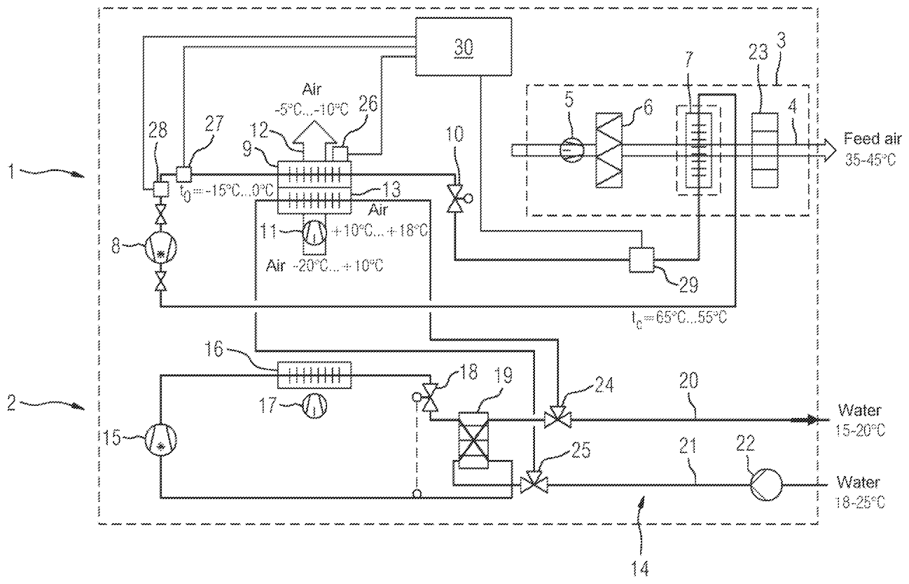

The invention relates to a vehicle for passenger transport according to the preamble of claim 1.

Accordingly, a vehicle for passenger transport is known,
comprising an electric drive device which is cooled uninterruptedly by means of a chiller during the operation of the vehicle, and
comprising an air-conditioning unit for air conditioning a passenger interior of the vehicle, wherein
the air-conditioning unit has an external heat exchanger, by means of which heat is taken from a surrounding area of the vehicle during a heat pump operation of the air-conditioning unit by virtue of ambient air being guided past the external heat exchanger by a fan assigned to the external heat exchanger, and
the electric drive device is cooled by means of a cooling circuit, the coolant of which is temperature-controlled by means of the chiller.

Such vehicles, especially rail vehicles, are suitable for ensuring propulsion of the vehicle without requiring the availability of overhead lines or a contact wire. In the past, diesel-driven vehicles were used for such fields of application. It is expected that, in future, these vehicles will be equipped with a battery or hydrogen drive provided on the vehicle itself. However, such drives are distinguished by a significant development of heat during the driving operation of the vehicle, and so they need to be cooled with the aid of a chiller. Additionally, stabling the vehicles in winter requires heating of the relevant electric drive devices. Since the available range of vehicles driven in this way is of great importance, it is ever more important to use efficient systems which have the smallest possible power uptake.

A compressor of the chiller in particular drains significant amounts of power from the battery in this case, in order to be able to provide a sufficient cooling power/heating power (heat pump operation). This in turn reduces an available range of the vehicle. Especially if, for the purpose of increasing the efficiency, a heat pump is simultaneously operated in the air-conditioning unit for the passenger interior air conditioning, defrosting processes may lead to an increase in the need for energy, and hence a reduction in the range of the vehicle.

In this context, the defrosting process for the external heat exchanger is triggered whenever low evaporation temperatures below 0° C. occur due to the heat pump operation and the external heat exchanger would freeze in the case of further cooling.

The defrosting process is performed by a process reversal in the cooling circuit of the air-conditioning unit and the “heat pump process” is reversed into a “cold process”. As a result, the external heat exchanger is heated (ambient air is heated) and the internal heat exchanger is cooled (feed air is cooled). In principle, the sequence of the flow through evaporator and condenser is reversed on the refrigerant side. The feed air, which should actually be heated in winter, is now cooled and “counter-heated” again by means of an electric heating register in the air-conditioning unit. Thus, the compressor and the heating register of the air-conditioning unit consume significant amounts of power during the defrosting process, which on average significantly reduces the use of the heat pump in terms of energy.

Proceeding therefrom, the invention is based on the object of further developing a vehicle of the type set forth at the outset, in such a way that the energy demand is reduced, and a range of the vehicle is increased.

In the vehicle as specified at the outset, this object is achieved by the features of claim 1.

Accordingly, the above-described vehicle is distinguished in that a waste-heat heat exchanger impinged by coolant flowing back from the electric drive device to the chiller is connected upstream of the external heat exchanger of the air-conditioning unit, in relation to the ambient air flow generated by the fan.

Thus, provision is made for the coolant flowing back to the chiller from the electric drive device, for example a battery or a fuel cell, to be used to pre-heat the ambient air flow such that either icing-up of the external waste-heat heat exchanger of the air-conditioning unit is effectively prevented or any future icing-up of this heat exchanger is reduced in terms of its manifestation.

As a result of the thermal interaction of the battery cooling circuit coolant, for example, with the battery for the purpose of cooling the latter, the flowing-back coolant has an elevated temperature when the chiller is in the cooling mode. The coolant controlled in terms of its temperature in this way is used with the aid of the upstream waste-heat heat exchanger, through which this coolant flows, to bring about pre-heating of the ambient air flow immediately upstream of the external heat exchanger of the air-conditioning unit. In the low external temperature range, the battery can preferably be cooled without a compressor of the cooling circuit for the electric drive device, and can be cooled using external air instead, which impinges on the waste-heat heat exchanger. The waste heat of the battery cooling can be used to increase the efficiency by way of condenser air pre-heating, both for the efficiency of the heat pump and for the defrosting process in the heat pump operation.

As a result, the defrosting process is shifted to lower external temperatures in comparison with the conventional procedure. Icing-up of the external heat exchanger is effectively prevented in the heat pump operation. On the contrary, the compressor of the chiller is required less or not at all during a de-icing process for the external heat exchanger with the aid of the waste heat from the electric drive device, and hence less electric power is required during the operation of the vehicle.

Preferably, an input side of the upstream waste-heat heat exchanger is flow-connected to an input side of an evaporator of the chiller and an output side of the upstream waste-heat heat exchanger is flow-connected to an output side of the evaporator of the chiller. This ensures that heated coolant flowing back from the electric drive device reaches the upstream waste-heat heat exchanger and brings about pre-heating of the ambient air flow at said location, whereafter said coolant is guided back to the chiller.

The electric drive device may preferably be formed by a battery (arrangement) or a fuel cell (arrangement). The vehicle can preferably be a railborne vehicle, in particular a rail vehicle such as a locomotive, a multiple unit, etc.

The external heat exchanger of the air-conditioning unit can be equipped with a temperature sensor for ascertaining an icing-up of the external heat exchanger, which is possible during heat pump operation in particular. In this case, it is possible that a control device of the air-conditioning unit deactivates a circuit of the air-conditioning unit, especially the compressor thereof, when icing-up of the external waste-heat heat exchanger is ascertained. Thereupon, the upstream waste-heat heat exchanger can be used for deicing the external waste-heat heat exchanger of the air-conditioning unit once the circuit of the air-conditioning unit has been shut down. Resumption of the operation of the air-conditioning unit is possible once the external heat exchanger has been defrosted.

Preferably, the cooling circuit for the electric drive device is separable from the air-conditioning unit by means of valves. This is advantageous for a cooling operation of the air-conditioning unit in summer since the external heat exchanger is not additionally loaded with waste heat from the cooling circuit for the electric drive device.

An exemplary embodiment of the invention will be explained in more detail hereinbelow on the basis of the figure, wherein temperature specifications contained herein are also only intended as examples and may depend on the type of utilized electric drive device. The single figure shows a schematic block diagram representation of an air-conditioning unit in combination with a chiller in a battery-operated rail vehicle.

The figure is divided into an upper part, which elucidates an air-conditioning unit 1 that is used for a passenger interior of a rail vehicle and is in the heat pump mode, for example for a winter operation of a vehicle, and a lower part, which shows a chiller 2 in a cooling mode for a drive battery of the rail vehicle. Instead of a battery drive, a fuel cell drive can likewise be provided; the description below can equally apply to the latter.

The air-conditioning unit 1 comprises an air treatment part 3, which serves to condition feed air 4 (e.g., 35 to 45° when leaving the air treatment part 3) for a passenger interior of the rail vehicle. To this end, the air treatment part 3 comprises a supply air fan 5 for sucking in fresh air/circulating air, an air filter 6, and a condenser 7, which has a coolant of the air-conditioning unit 1 flowing therethrough and thermally interacts with the sucked-in fresh air/circulating air.

Moreover, the air-conditioning unit 1 comprises a compressor 8, an external heat exchanger (evaporator) 9, and an expansion valve 10 outside of the air treatment part 3.

The air-conditioning unit 1 can be used both in a heating operation and in a cooling operation. If the air-conditioning unit 1 is used for heating purposes, it operates as a heat pump, as illustrated in the figure, wherein, at the external heat exchanger 9, thermal energy is taken from the ambient air guided past the external heat exchanger 9 by means of a fan 11 in order to heat the coolant of the air-conditioning unit 1. By way of example, the temperature of the ambient air entering the fan 11 is −20 to 10° C., and −5 to −10° C. at the external heat exchanger 9. Following the heat exchange between the external heat exchanger 9 and the coolant of the air-conditioning unit 1, the coolant is at a temperature of −15 to 0° C. After leaving the external heat exchanger 9, the heated coolant reaches the condenser 7 of the air-conditioning unit 1 via the compressor 8. Upon entrance into the condenser 7, the temperature of the coolant is at 65 to 55° C.

When the air-conditioning unit 1 is operated as a heat pump, the external heat exchanger 9 may ice up depending on the ambient air temperature present.

To prevent or counteract an icing-up of the external heat exchanger 9, a waste-heat heat exchanger 13 arranged between the fan 11 and the external heat exchanger 9 is disposed upstream of the external heat exchanger 9, in relation to a flow direction of the ambient air flow 12.

The temperature of the ambient air at the waste-heat heat exchanger 13 is 10 to 18° C.

A coolant, water in this case, of a battery cooling circuit 14 flows through the waste-heat heat exchanger 13 provided.

A flow temperature of the coolant of the battery cooling circuit is determined by the chiller 2. The chiller 2 comprises a compressor 15, a condenser 16 and associated condenser fan 17, an expansion valve 18, and an evaporator 19.

There is a thermal interaction of a coolant of the chiller circuit with the refrigerant of the battery cooling circuit 14 at the evaporator 19 of the chiller 2. The compressor 15 in particular, which is supplied with electrical power by the battery arrangement like the rail vehicle as a whole, requires significant amounts of electrical power for the operation thereof. This applies equally to a driving operation of the rail vehicle, when the battery arrangement needs cooling, and in the case where the vehicle is stabled and, for example in winter, the battery arrangement needs to be heated so as to maintain its specified operating temperatures. During the driving operation of the rail vehicle, the chiller 2 is in its cooling mode, wherein a flow temperature in a feed line 20 of the battery cooling circuit 14 is significantly lower (e.g., 15-20° C.) than a return temperature (e.g., 18-25° C.) in a return line 21.

Before the evaporator 19 is reached, cooling water heated by the cooling process of the battery arrangement is conducted from the return line 21 of the battery cooling circuit 14 to the waste-heat heat exchanger 13, which is disposed upstream of the external heat exchanger 9 of the air-conditioning unit 1. The ambient air is pre-heated by the thermal interaction of the heated cooling water with the ambient air at the waste-heat heat exchanger 13. As a result of the pre-heated ambient air, an icing-up of the external heat exchanger 9 of the air-conditioning unit 1 is either counteracted or such an icing-up of the external heat exchanger 9 is even avoided in full. In turn, this has as a consequence that a defrosting of the external heat exchanger 9 can be brought about in the “cold process”, then present, of the air-conditioning unit, without using a heating register 23 for heating the feed air for the passenger interior, or that the heating register can be operated with less electrical power.

At the same time, the cooling water cooled at the waste-heat heat exchanger 13 is returned to the feed line 20 of the battery cooling circuit 14. In relation to a flow direction of the cooling water of the battery cooling circuit 14 determined by a pump 22 in the return line 21, an input side of the upstream waste-heat heat exchanger 13 is consequently flow-connected to an input side of the evaporator 19 of the chiller 2 and an output side of the upstream waste-heat heat exchanger 13 is flow-connected to an output side of the evaporator 19 of the chiller.

Since consequently a part of the cooling water flowing back to the chiller 2 via the return line 21 is subjected to the pre-heating process at the waste-heat heat exchanger 13, the compressor 15 can be operated using less electrical power since it need not cool all of the heated cooling water reaching the evaporator 19 via the return line 21 down to a suitable temperature. Depending on the extent to which the cooling water has already been cooled at the waste-heat heat exchanger 13, it may optionally be possible to completely dispense with an operation of a compressor 15, thereby entailing significant savings in terms of electrical power.

In summary, it should be established that the pre-heating of the ambient air at the waste-heat heat exchanger 13 for defrosting processes of the external heat exchanger 9 makes it possible to save electrical power for a heating register provided. Moreover, electrical power is also saved by an increased energy-saving operation of the compressor 15. In this respect, the measures taken bring about a reduced consumption of electrical power for the overall system of air-conditioning unit 1, chiller 2, and battery cooling circuit 14.

For summer operation, in particular, provision is made for the cooling circuit for the electric drive device to be separable from the air-conditioning unit 1 by means of valves 24, 25. In this case, the heated cooling water interacts only with the evaporator 19 of the chiller 2.

Moreover, this exemplary embodiment provides for the external waste-heat heat exchanger 9 of the air-conditioning unit 1 to be equipped with a temperature sensor 26, which is arranged at the external heat exchanger 9 and serves to ascertain an icing-up of the external waste-heat heat exchanger 9. Moreover, the assessment as to whether or not a defrosting procedure is required also includes measurement values provided by a suction gas temperature sensor 27, a suction pressure sensor 28, and optionally also a high-pressure sensor 29. The sensors 26, 27, 28, 29 are all signal-connected to a control device 30 of the air-conditioning unit 1 and the circuit of the air-conditioning unit 1 is deactivated by the control device should an icing-up of the external waste-heat heat exchanger 9 that renders a defrosting procedure necessary be ascertained.

1-7. (canceled)

8. A vehicle for passenger transport, the vehicle having an electric drive device and a passenger interior, the vehicle comprising:
an air-conditioning unit for air conditioning the passenger interior of the vehicle;
said air-conditioning unit having an external heat exchanger configured to take heat from a surrounding of the vehicle during a heat pump operation of the air-conditioning unit, wherein an ambient air flow generated by a fan is guided past said external heat exchanger;
a cooling circuit for uninterruptedly cooling the electric drive device during an operation of the vehicle, and a chiller configured to control a temperature of a coolant of said cooling circuit; and
a waste-heat heat exchanger connected upstream of said external heat exchanger of said air-conditioning unit, relative to the ambient air flow generated by said fan, said waste-heat heat exchanger being impinged by the coolant flowing back from the electric drive device to said chiller.

9. The vehicle according to claim 8, wherein said chiller comprises an evaporator, and wherein an input side of said upstream waste-heat heat exchanger is flow-connected to an input side of said evaporator of said chiller and an output side of said upstream waste-heat heat exchanger is flow-connected to an output side of said evaporator of said chiller.

10. The vehicle according to claim 8, wherein said electric drive device is a battery or a fuel cell.

11. The vehicle according to claim 8, wherein the vehicle is a railborne vehicle.

12. The vehicle according to claim 8, wherein said external heat exchanger of said air-conditioning unit is equipped with a temperature sensor for ascertaining an icing-up of said external heat exchanger.

13. The vehicle according to claim 12, wherein said air-conditioning unit has a control device signal-connected to said temperature sensor and said control device is configured to deactivate a circuit of said air-conditioning unit upon ascertaining an icing-up of said external heat exchanger.

14. The vehicle according to claim 8, which comprises valves disposed to enable said cooling circuit for the electric drive device to be flow-separated from said air-conditioning unit.
